(19) United States
(12) Patent Application Publication
(10) Pub. No.: US 2003/0174434 A1
(43) Pub. Date: Sep. 18, 2003

(54) Access slot for cartridge storage magazine

(75) Inventors: Haavard Hoelsaeter, Oslo (NO); Truls Simensen, Hagan (NO)

Correspondence Address: SCHIFF HARDIN & WAITE, 6600 SEARS TOWER, 233 S WACKER DR, CHICAGO, IL, 60606-6473, US

(73) Assignee: Tandberg Data ASA

(21) Appl. No.: 10/162,737

(22) Filed: Jun. 4, 2002

Related U.S. Application Data
(60) Provisional application No. 60/341,657, filed on Dec. 14, 2001.

(51) Int. Cl. G11B 15/68

(52) U.S. Cl. 360/92

(57) ABSTRACT

An automated cartridge handling apparatus includes a cartridge storing magazine in which a plurality of cartridges are stored, such as between use in a cartridge drive. Transport of the cartridges between the drive and the cartridge storage magazine is accomplished by a cartridge shuttle having access at openings in an access side of the cartridge storage magazine. An access door is provided in a back surface of the cartridge storage magazine for selectively removing a cartridge from the corresponding cartridge storage slot in the magazine. The access door permits access to the cartridges without removal of the magazine from the automated cartridge handling apparatus.

### CROSS REFERENCE TO RELATED APPLICATION

This application claims the benefit of Provisional Patent Application Serial No. 60/341,657, filed Dec. 14, 2001.

### BACKGROUND OF THE INVENTION

1. Field of the Invention

The present invention relates generally to a storage magazine for storing cartridges, and in particular to a storage magazine for an automated cartridge handling apparatus and to a method.

2. Description of the Related Art

Automated cartridge handling apparatuses move cartridges from a cartridge drive, such as a magnetic tape cartridge drive, to cartridge storage magazines. The automated cartridge handling apparatus includes, for example, a shuttle which selectively removes the cartridges from the cartridge storage magazines and inserts it into the drive for recording and/or playback of data on the cartridge. When the drive is finished with the cartridge, the shuttle moves the cartridge back to the storage magazine and stores it in a slot therein. If it is desired to replace of the cartridges stored in the magazine, it is necessary to remove the entire magazine from the automated cartridge handling apparatus.

### SUMMARY OF THE INVENTION

A cartridge storage magazine is provided for use, for example, with an automated cartridge handling apparatus. The cartridge storage magazine includes a front side having openings accessible to the automated cassette handling apparatus and a rear wall opposite the front openings. According to a development of the invention, the rear wall of the cartridge storage magazine includes a selectively openable door for access to at least one of the storage slots of the cartridge storage magazine.

### BRIEF DESCRIPTION OF THE DRAWINGS

FIG. 1 is a perspective view of an automated cartridge handling apparatus showing an access door opened to reveal a cartridge storage magazine;

FIG. 2 is a perspective view of the cartridge handling apparatus of FIG. 1 showing a mail slot door open for accessing a cartridge stored in a corresponding storage slot of the cartridge storage magazine;

FIG. 3 is a perspective view of the cartridge storage magazine removed from the automated cartridge handling apparatus;

FIG. 4 is a perspective view of the cartridge storage magazine of FIG. 3 showing a mail slot door opened to access a cartridge stored therein;

FIG. 5 is a perspective view of an autoloader component including the storage magazine of the present invention; and

FIG. 6 is a perspective view of an interior of an autoloader device.

### DETAILED DESCRIPTION OF THE PREFERRED EMBODIMENTS

The following preferred embodiments are described without limitation to the scope of the claims.

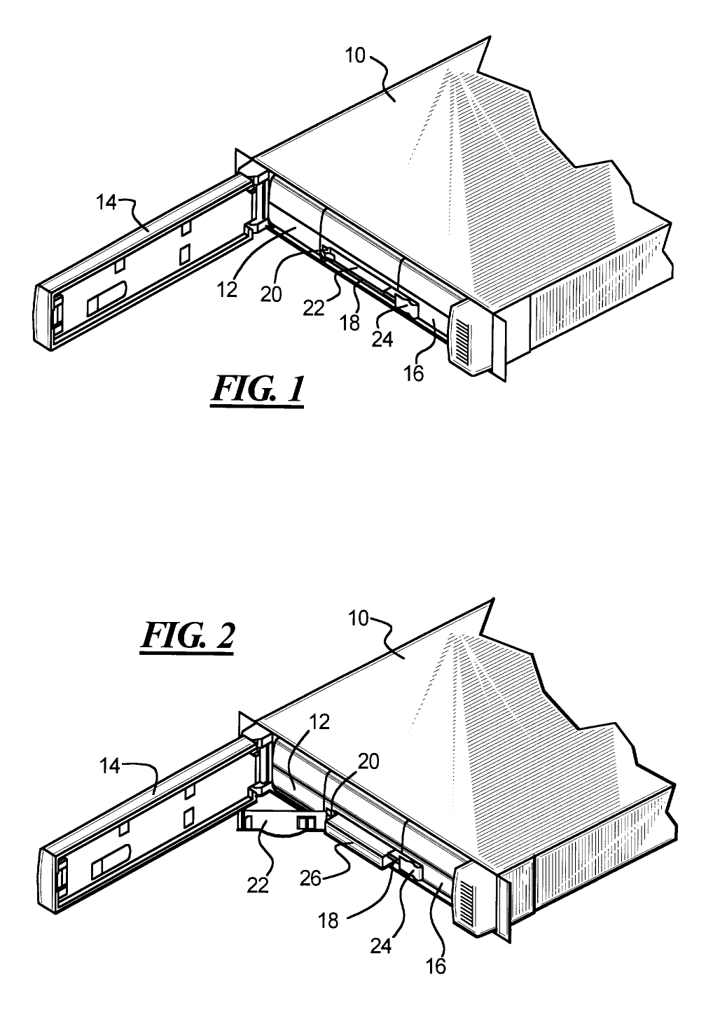

In FIG. 1, an automated apparatus for handling cartridges is shown having an external housing 10. Inside the housing is an automated cartridge handling apparatus including a shuttle and a cartridge drive providing automated recording and playback of data on the cartridges. The cartridges for use in the drive are stored by the shuttle apparatus in a cartridge storage magazine 12. The cartridge storage magazine 12 is selectively removable from the housing 10 of the automated cartridge handling apparatus. For example, a door 14 on the housing 10 may be opened to access a rear wall 16 of the cartridge storage magazine 12. The magazine 12 can be ejected from the automated cartridge handling apparatus, such as by activation of an eject and initialization routine by the operator. Running the eject and initialization routine is a time consuming operation and reduces the efficiency of the present cartridge handling apparatus. Accordingly, a mail slot 18 is provided in the back wall 16 of the magazine 12. The mail slot includes a hinge 20, a door 22, and a latch 24. The mail slot 18, in the illustrated embodiment, provides access to one of the cartridge storage slots of the magazine 12. In the illustrated example, the cartridge storage magazine 12 holds nine cartridges, three cartridges side by side and three high. The mail slot 18 provides access to the middle lower storage slot of the magazine 12, in the illustrated embodiment.

By activation of the latch 24, such as by sliding the latch 24 sideways with a thumb or finger, the door 22 is released so that it can swing open on the hinge 20, as shown in FIG. 2. The latch 24 is preferably biased to a closed position by a spring. Once the door 22 is open, a cartridge 26 in the corresponding storage slot of the storage magazine 12 can be removed. A different cartridge 26 may be inserted into the mail slot 18 when the door 22 is open. In this way, the cartridges 26 in the automated cartridge handling apparatus may be exchanged for other cartridges without re-initializing the automated cartridge handling apparatus and without removal of the entire cartridge storage magazine.

In FIG. 3, the cartridge storage magazine 12 is shown removed from the automated cartridge handling apparatus 10. The mail slot 18 with its door 22 is shown in the closed position on the back wall 16 of the storage magazine 12. As mentioned above, the illustrated embodiment of the storage magazine 12 stores six cartridges, each in its own slot. The cartridges are accessible from front openings of the magazine 12 which are opposite the back surface 16. Each of the slots includes a latch, indicated at 28, to secure the cartridge in the slot.

To facilitate handling of the magazine 12, a grip section 30 with recessed channels is provided on the top surface 32 of the magazine 12, and corresponding grips are provided on the underside as well. The grip section 30 is engaged by the user's hand while removing the magazine 12 from the automated cartridge handling apparatus, carrying the magazine 12, and inserting the magazine 12 into the automated cartridge handling apparatus.

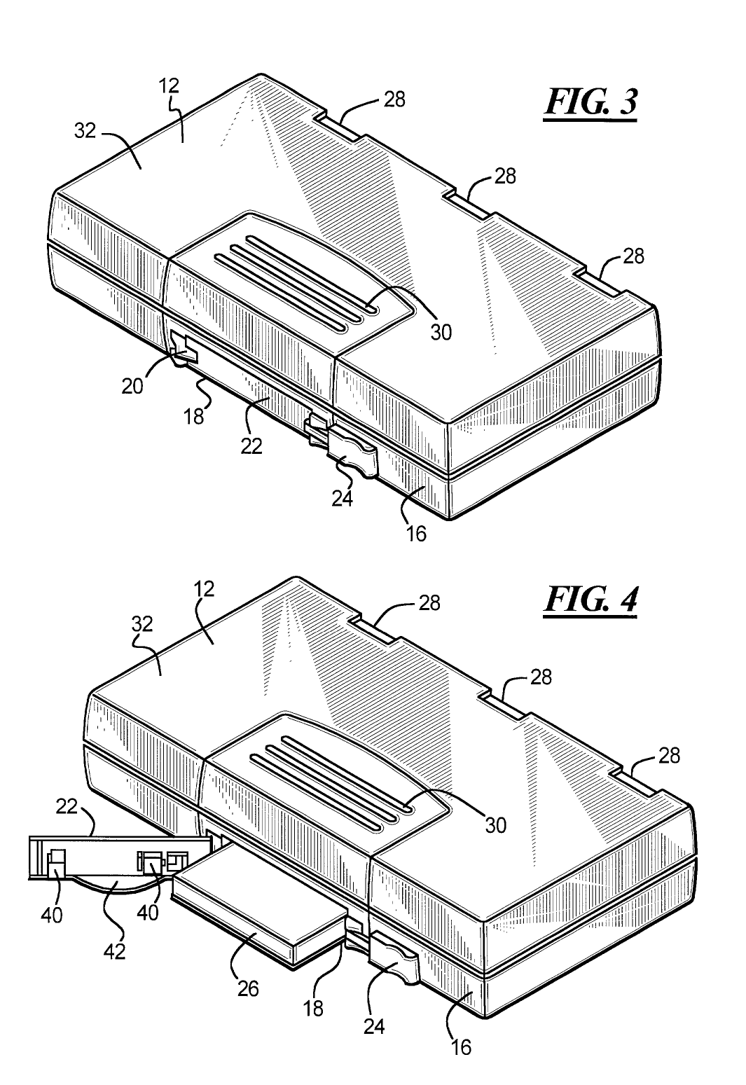

Referring to FIG. 4, the door 22 is open with the cartridge 26 extending from the mail slot 18. The door 22 includes leaf springs 40 on the inside surface which press against the cartridge 26 and urge it against the latch 28. The door 22 has a semi-circular projection 42 at the bottom edge thereof which fits into a similarly shaped opening at the bottom of the mail slot 18. This semi-circular opening provides an access space so that the user may easily grip the cartridge 26 for removal from the mail slot 18.

The automated cartridge handling apparatus of one embodiment provides a compact unit and is, for example, mountable in a 19″ rack. This restricts the area for access to the apparatus. Further, access to the mail slot is possible without ejecting the magazine 12.

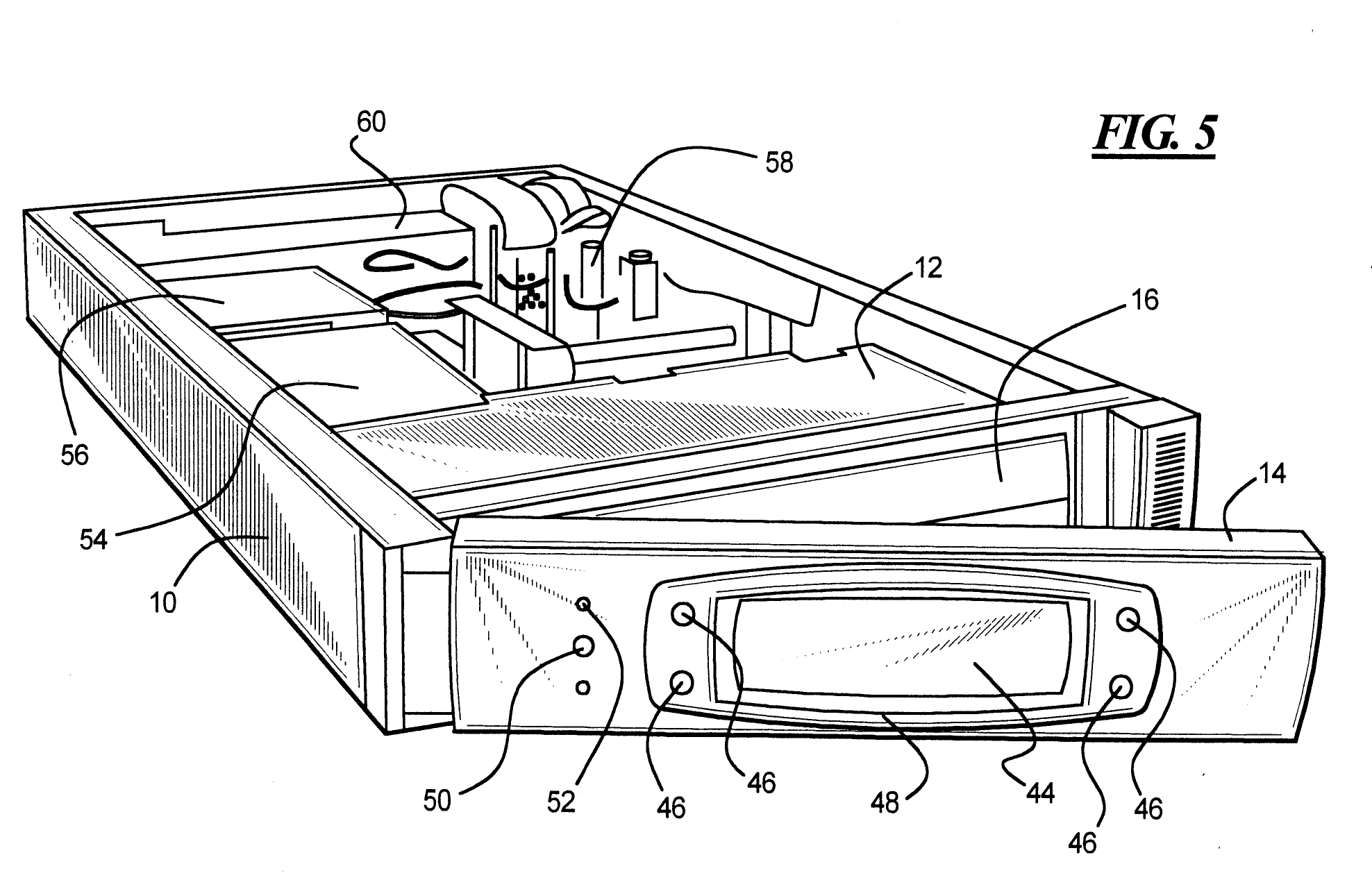

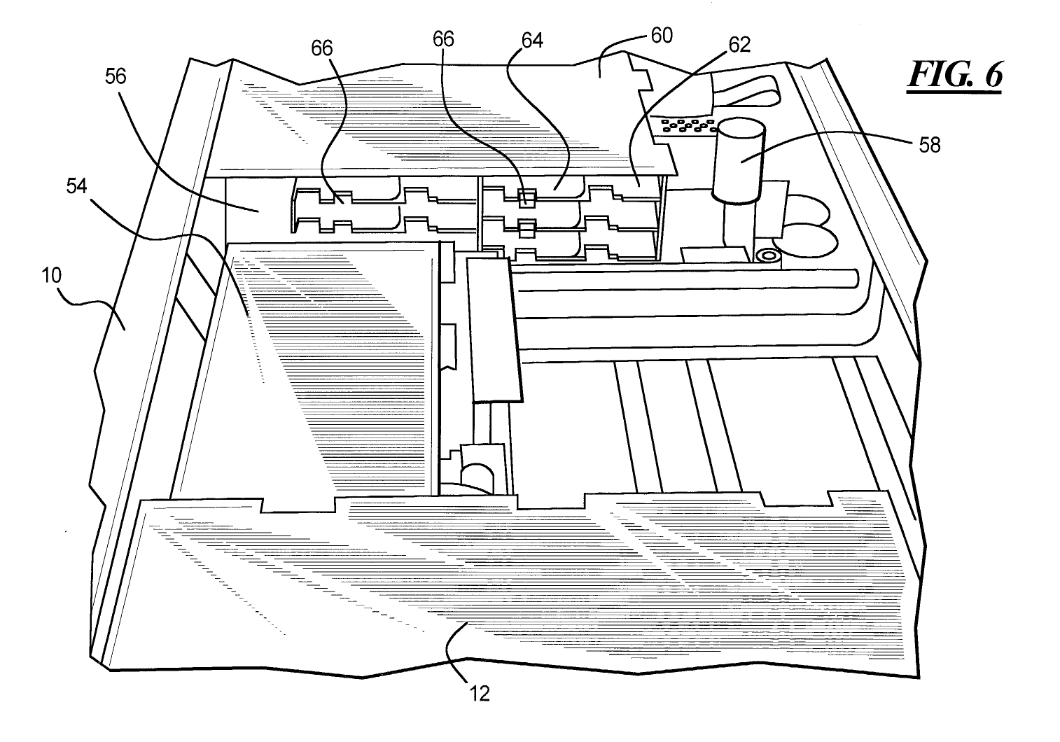

An example of the automated cartridge handing apparatus, also termed an autoloader, is shown in FIG. 5. The door 14 is open and the rear wall 16 of the storage magazine 12 is visible. The door 14 has a display screen 44 on which is displayed information relating to the operating status of the autoloader device. Control buttons 46 are provided on a frame 48 of the display screen 44 by which the user controls and communicates with the autoloader device. Also on the door 14 is a power button 50 and indicator lights 52, indicating a ready status.

The door 14 is shown pivoted to the open position for access to the mail slot 18. The door 14 pivots to a closed position and is latched for normal operation of the autoloader. However, as indicated above, the door 14 may be opened for access to the mail slot 18 without a full power down and re-initialization of the device.

The external housing 10 of the autoloader is shown in FIG. 5 with the top panel removed. Within the housing 10 is the storage magazine 12 extending across a substantially portion of the front of the autoloader device. The storage magazine 12 has a width and height a little less than the dimensions of the external housing 10. Put another way, the external housing 10 need be only as big in height and width as required to house the storage magazine 12.

A cartridge shuttle mechanism 54 is provided in the housing 10 which accesses cartridges 26 stored in the storage magazine 12. The shuttle 54 is automatically movable between the different storage slots in the storage magazine 12 and so may access cartridges 26 stored in each of the storage slots. For example, the shuttle 54 moves back and forth along the front of the storage magazine 12 to access the side-by-side slots and up and down to access the slots positioned above one another. The shuttle 54 carries the cartridges 26 to a cartridge drive 56, also visible in the housing 10 but at the end opposite the storage magazine 12. The shuttle 54 has a front opening at the storage magazine 12 through which the cartridges 26 are transferred to and from the magazine 12, and a rear opening at the drive 56 through which the cartridges 26 are transferred to and from the drive 56. The shuttle 54 moves the cartridges 26 only by translation and not by rotation so that the cartridges 26 maintain their proper orientation within the device to ensure the correct position for loading into the drive 56. The drive 56 operates to record and/or read data from the tape within the cartridge 26. Automatic loading and unloading of the cartridges 26 to and from the drive 56 is provided, the cartridges 26 being stored in the storage magazine 12 when not in use by the drive 56.

Also in the housing 10 is a power supply 58 and control circuits 60 for the display screen 44, the shuttle 54 and the drive 56.

The embodiment illustrated in FIG. 5 has a single storage magazine 12. It is contemplated to provide an autoloader with a plurality of storage magazines. For example, FIG. 6 shows an embodiment with a second storage magazine 62 comprising three storage slots 64 positioned at the rear of the autoloader adjacent the drive 56. Further storage space is thus available for additional cartridges 26. Each of the slots 64 is provided with a latch 66 which secures the cartridge 26 into the slot. The magazine 12 is also provided with latches 66 as each of the storage slots.

Each of the illustrated embodiments enables the cartridges 26 to be stored in the storage magazine 12, transferred from the magazine 12 to the drive 56 and stored again after use. The shuttle 54 also moves the cartridges 26 from slot to slot in the storage magazine 12, so that the cartridge 26 that is inserted into the mail slot 18 may be moved by the shuttle 54 to another slot or to the drive 56 and then a further cartridge 26 inserted into the mail slot 18. Likewise, the cartridge 26 in the slot at which the mail slot 18 is found can be removed and then the shuttle 54 may transfer a further cartridge 26 from another slot or from the drive 56 to the mail slot 18 for removal. Of course, these procedures may be repeated as often as needed to transfer cartridges 26 into and out of the autoloader device without the need to remove the storage magazine 12 or re-initialize the device.

Other embodiments of storage magazine are of course possible including other numbers of storage slots. For example, a storage magazine having six magazine slots, or eight, or twelve, is contemplated, as is storage magazines of other numbers of slots.

It is foreseeable to provide a larger mail slot for simultaneous access to more than one of the storage slots in the magazine so that two or more cartridges may be removed through the single mail slot. Alternately, two or more mail slots may be provided on a single magazine for access to two or more corresponding storage slots.

Thus, there has shown and described a mail slot for access to cartridge storing magazines. The cartridge storage magazines may be used in automated cartridge handling apparatus or may instead merely be storage magazines without an associated cartridge handling apparatus.

Although other modifications and changes may be suggested by those skilled in the art, it is the intention of the inventors to embody within the patent warranted hereon all changes and modifications as reasonably and properly come within the scope of their contribution to the art.

We claim:

1. A cartridge storage magazine for storing cartridges, comprising:
walls defining cartridge storage slots in which the cartridges are stored, said cartridge storage slots having a front access opening;
a back wall of said cartridge storage magazine closing said cartridge storage slots at a back thereof opposite said front openings;
an openable door in said back surface at at least one of said storage slots; and
a latch engaging said door to secure said door in a closed position, said latch being selectively releasable to open said door for access to said at least one slot.

2. A cartridge storage magazine as claimed in claim 1, wherein said door includes an extension at a bottom edge and wherein said cartridge storage magazine includes a correspondingly shaped recessed which is closed by said extension on said door when said door is in a closed position and which provides a hand gripped access space for gripping a cartridge i said at least one slot when said door is open.

3. A cartridge storage magazine as claimed in claim 1, further comprising:
a leaf spring mounted on an inside surface of said door for pressing against a cartridge in said at least one cartridge storage slot when said door is in a closed position.

4. A cartridge storage magazine as claimed in claim 1, wherein said walls define a plurality of said cartridge storage slots, and said door provides access to only one of said cartridge storage slots.

5. Method for operating an automated cartridge handling apparatus, comprising the steps of:
providing a cartridge storage magazine having a plurality of cartridge storage locations;
accessing cartridges stored in said cartridge storage slots with an automated cartridge handling apparatus, said automated cartridge handling apparatus accessing said cartridges through front openings in said cartridge storage magazine;
providing an access door in a back wall of said cartridge storage magazine opposite said front openings;
selectively accessing a cartridge stored in a storage slot accessible by said access door.

6. An autoloader for cartridges, comprising:
a housing;
a drive for the cartridges in said housing;
a shuttle in said housing disposed adjacent said drive to feed the cartridges to said drive;
a storage magazine in said housing disposed adjacent said shuttle, said storage magazine having a plurality of storage slots capable of storing the cartridges;
said storage magazine being capable accessing cartridges stored in said plurality of storage slots;
a mail slot in said storage magazine at one of said storage slots through which a cartridge is removable without removing said storage magazine from said housing.

7. An autoloader as claimed in claim 6, further comprising:
a door on said housing, said door being disposed over said mail slot when in a closed position, said door permitting access to said mail slot when in an open position.

8. An autoloader as claimed in claim 6, wherein said mail slot includes a mail slot door selectively fastenable to close said mail slot.
